(19) United States
(12) Patent Application Publication
(10) Pub. No.: US 2025/0124205 A1
(43) Pub. Date: Apr. 17, 2025

(54) CONTENT-AWARE APPORTIONMENT OF ESTIMATED TIMING SLACK

(71) Applicant: International Business Machines Corporation, Armonk, NY (US)

(72) Inventors: Chris Cavitt, Queensbury, NY (US); Chaobo Li, Wappingers Falls, NY (US); Jesse Peter Surprise, Highland, NY (US); Mark Cohen, POUGHKEEPSIE, NY (US)

(21) Appl. No.: 18/488,118

(22) Filed: Oct. 17, 2023

(51) Int. Cl. G06F 30/3312; G06F 119/12

(52) U.S. Cl. CPC G06F 30/3312; G06F 2119/12

(57) ABSTRACT

In an integrated circuit design, slack on a signal path of an integrated circuit design can be apportioned in order to accelerate design refinement. According to one method, timing analysis of the signal path of the integrated circuit design is performed. Estimated (as opposed to actual) slack on the signal path is determined through content-based analysis of components of the signal path based on elimination of timing inefficiencies within the components. The estimated slack is then proportionally apportioned among the components of the signal path for use in a subsequent iteration of design refinement.

### BACKGROUND OF THE INVENTION

The present invention relates in general to integrated circuitry, and more specifically, to techniques for designing integrated circuitry. Still more particularly, the present invention relates to timing within an integrated circuit design.

The development of an integrated circuit (IC) involves a number of principal stages, including, for example, specification, logic design, physical design, verification, fabrication, and packaging and testing. In concert with the physical design, timing analysis is often performed to determine whether or not various signals satisfy timing requirements of the IC design, such as a the setup and hold times of latches. Deviation of the timing of a signal from a required arrival time is referred to as “slack.” Positive slack refers to signal timing in advance of the required arrival time, and negative slack refers to signal timing that behind the required arrival time.

Following timing analysis, signal timing can be improved through slack apportionment techniques, which allocate positive and/or negative slack among the circuit components contributing to the slack. Apportionment of the slack in turn modifies a signal launch and/or a signal arrival time to achieve a required arrival time.

### SUMMARY OF THE INVENTION

In at least one embodiment, improvements are made to the apportionment of slack on a signal path of an integrated circuit design in order to accelerate design refinement. According to one exemplary method, timing analysis of the signal path of the integrated circuit design is performed. Estimated (as opposed to actual) slack on the signal path is determined through content-based analysis of components of the signal path based on elimination of timing inefficiencies within the components. The estimated slack is then proportionally apportioned among the components of the signal path for use in a subsequent iteration of design refinement.

### BRIEF DESCRIPTION OF THE DRAWINGS

FIG. 1 is a high-level block diagram of an exemplary data processing environment in accordance with one or more embodiments;

FIG. 2 is a high-level block diagram of an exemplary integrated circuit design hierarchy in accordance with one or more embodiments;

FIG. 3 is a high-level logical flowchart of an exemplary method for apportioning slack in accordance with one or more embodiments;

FIG. 4 illustrates exemplary apportionment of negative slack in accordance with the method of apportioning slack given in FIG. 3; and

FIG. 5 illustrates an exemplary design process in accordance with one or more embodiments.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as integrated circuit design tool 150 enabling development of an integrated circuit design 200. In addition to integrated circuit design tool 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and integrated circuit design tool 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

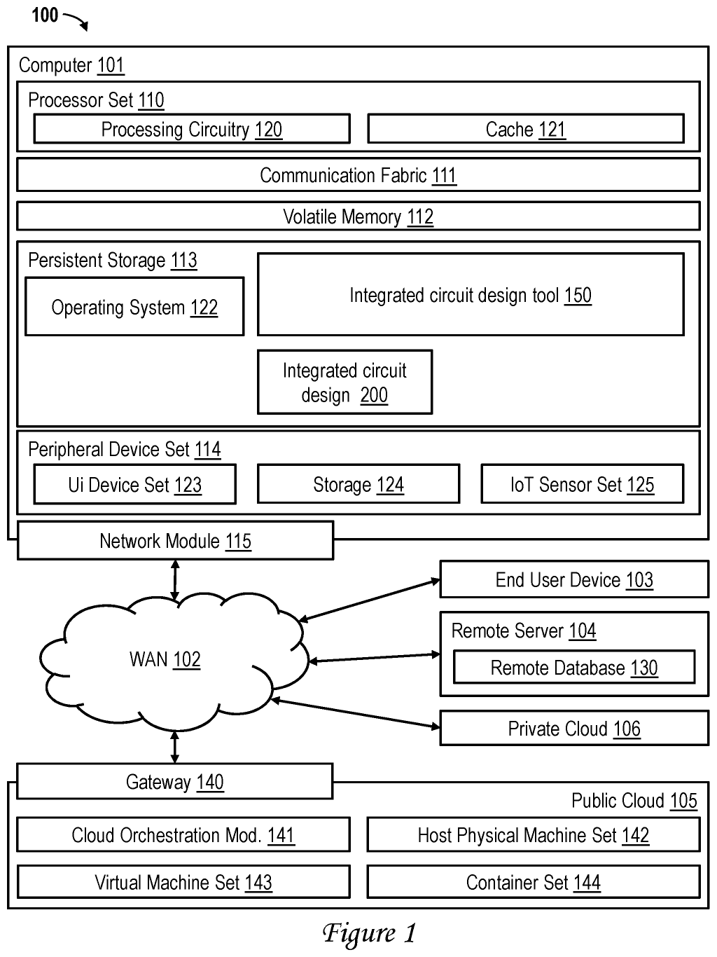

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in integrated circuit design tool 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet-of-Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the Internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the Internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Those of ordinary skill in the art will appreciate that the architecture and components of a data processing environment can vary between embodiments. Accordingly, the exemplary computing environment 100 given in FIG. 1 is not meant to imply architectural limitations with respect to the claimed invention.

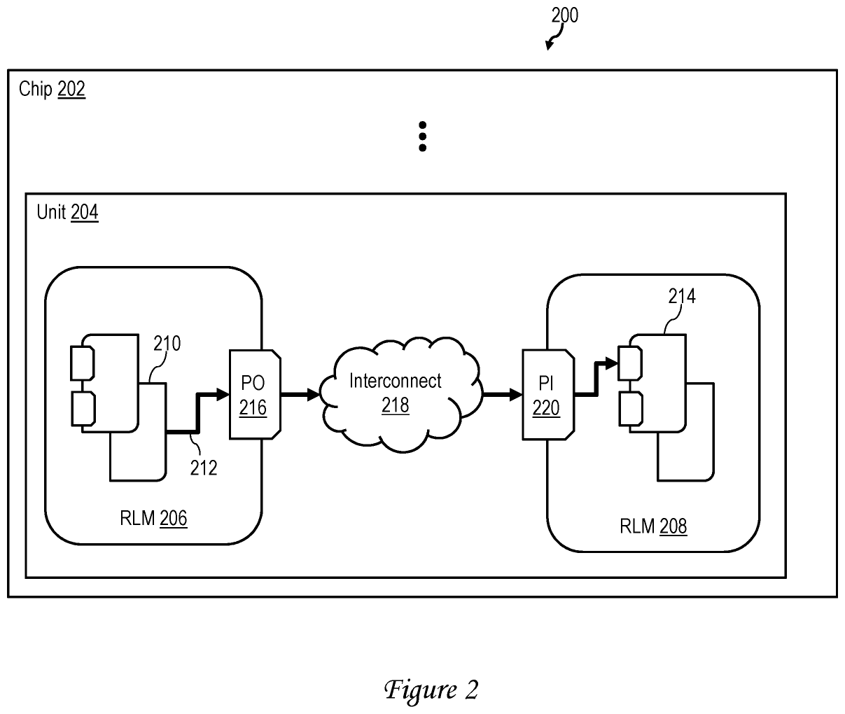

Referring now to FIG. 2, there is depicted an exemplary integrated circuit design 200 in accordance with one or more embodiments. Integrated circuit design 200 can be represented, for example, by one or more files within a storage device of a data processing system, as discussed above with reference to FIG. 1. Integrated circuit design 200 includes a design hierarchy having multiple levels. In the depicted example, the design hierarchy includes, at a highest level, a chip entity 202, which in turn includes, at an intermediate level of the design hierarchy, a unit entity 204 that in turn includes random logic macro (RLM) entities 206 and 208 at a lower level of the design hierarchy. Those skilled in the art will appreciate that integrated circuit design 200 can include additional levels of design hierarchy and multiple entities at each of one or more lower levels of the design hierarchy. By way of illustration rather than limitation, unit entity 204 may include additional RLM entities in addition to RLM entities 206 and 208, and chip entity 202 may include one or more unit entities in addition to unit entity 204.

In the depicted example, RLM entity 206 includes a first latch 210 that sources a signal 212 that is received by a second latch 214 in RLM entity 208. Signal 212 is output from RLM entity 206 at output pin (PO) 216, traverses an interconnect 218, and is received by RLM entity 208 at input pin (PI) 220. Once placement and routing has been performed on unit 204 to generate at least a preliminary physical design, timing analysis can be performed to determine whether or not signal 212 meets a required arrival time at latch 214, which can be based on, among other factors, the setup and hold times of latch 214. As noted above, until the physical design of an integrated circuit design, such as integrated circuit design 200, is finalized, it is common for a signal path, such as the exemplary signal path including RLM entities 206-208 and interconnect 218, to exhibit either positive or negative slack. As the logical and/or physical design of the integrated circuit design is iteratively refined, the slack, if any, of each signal path is apportioned among the contributors to the slack in order to appropriately allocate responsibility for meeting required arrival times of signals during a subsequent design iteration.

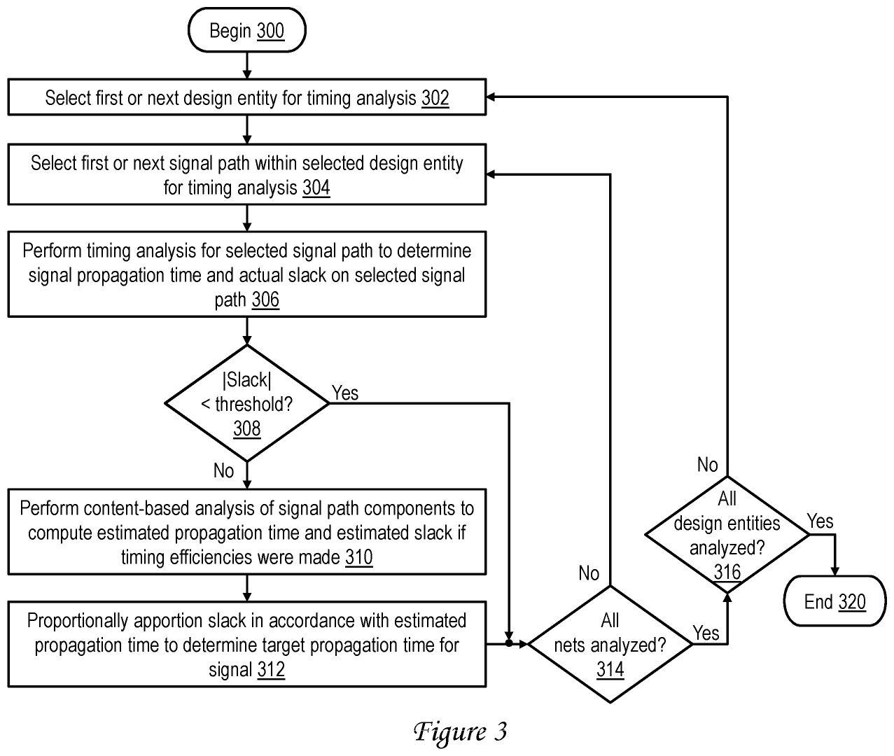

With reference now to FIG. 3, there is illustrated a high-level logical flowchart of an exemplary method for apportioning slack in accordance with one or more embodiments. The method of FIG. 3 can be performed, for example, through execution of integrated circuit design tool 150 by processing circuitry 120 of computer 101 to perform timing analysis of integrated circuit design 200.

The process of FIG. 3 begins at block 300 and then proceeds to block 302, which illustrates processing circuitry 120 selecting a first (or next) design entity of integrated circuit design 200 on which to perform timing analysis. As will be appreciated by those skilled in the art, the design entity selected at block 302 can be within any desired scope of the design hierarchy up to and including chip entity 202. At block 304, processing circuitry 120 additionally selects a next signal path within the selected design entity on which to perform timing analysis. For purposes of illustration, processing circuitry 120 may select unit entity 204 at block 302 and may select the signal path including RLM entities 206-208 and interconnect 218 at block 304. Based on the selections made at blocks 302 and 304, processing circuitry 120 performs timing analysis on the selected signal path utilizing possibly conventional techniques (block 306). Performing timing analysis on the selected signal path results in a determination of the latch-to-latch propagation time of the signal on the selected signal path as well as the positive or negative slack for the signal relative to a target propagation time.

At block 308, processing circuitry 120 determines whether or not the magnitude of the slack (positive or negative) determined at block 306 is less than a threshold slack selected for the signal path for the current design iteration. Based on a determination that the magnitude of the slack is less than the predetermined threshold, the process passes to block 314, which is described below. However, in response to processing circuitry 120 determining at block 308 that the magnitude of the calculated slack is greater than or equal to the selected threshold, processing circuitry 120 performs content-based analysis of components contributing to the slack to automatically compute an estimated slack that would result if timing efficiencies were made to the components (i.e., timing inefficiencies were eliminated from the components) (block 310). For example, in some cases, the inclusion within a macro of a delay book imposing a timing delay of known duration on a critical path can delay the signal of the signal path, causing an unnecessarily high negative slack. Alternatively or additionally, processing circuitry 120 can determine at block 310 that routing, slew, or noise issues are delaying the signal. The portion of the slack attributable to such timing inefficiencies are deducted by processing circuitry 120 from the slack determined at block 306 to compute the estimated slack at block 310.

At block 312, processing circuitry 120 automatically proportionally allocates the estimated slack computed at block 310 among the signal path components contributing to the estimated slack. Thus, in the exemplary signal path illustrated in FIG. 2, processing circuitry 120 proportionally allocates the slack among RLM entity 206, interconnect 218, and RLM entity 208. This slack can then be reduced by the design team member(s) responsible for each of these signal path components during a next iteration of design refinement in order to achieve (or at least converge toward) a target propagation time for signal 212. The process proceeds from block 312 to block 314, which depicts processing circuitry 120 determining whether or not all signal paths within the selected design entity have been analyzed. If not, the process returns to block 304 and proceeds iteratively. If, however, processing circuitry 120 determines at block 316 that all signal paths within the selected design entity have been analyzed, processing circuitry 120 additionally determines at block 316 whether or not all design entities within the selected scope of the design hierarchy have been analyzed. If not, the process returns to block 302 and proceeds iteratively. If, however, processing circuitry 120 determines at block 316 that all design entities within the selected scope of the design hierarchy have been analyzed, the process of FIG. 3 terminates at block 320.

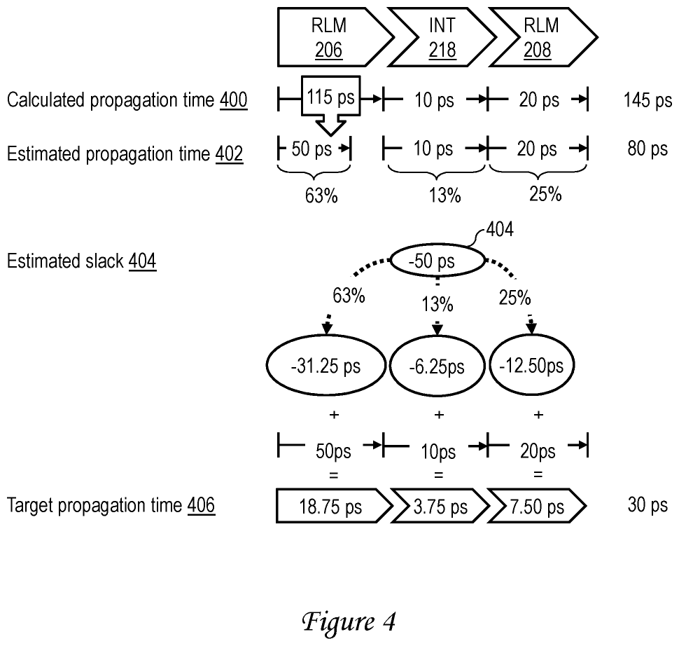

FIG. 4 depicts an exemplary apportionment of negative slack in accordance with the exemplary method of apportioning slack given in FIG. 3. In this example, at block 306 of FIG. 3, processing circuitry 120 calculates the propagation time of signal 212 on the signal path including RLM entity 206, interconnect 218, and RLM entity 208 as 145 picoseconds (ps). As indicated, in this example, the calculated propagation time includes 115 ps of propagation time in RLM entity 206 (i.e., between latch 210 and output pin 216), 10 ps of propagation time on interconnect 218 (i.e., between output pin 216 and input pin 220), and 20 ps of propagation time in RLM entity 208 (i.e., between input pin 220 and latch 214). Based on content-based assessment of RLM entity 206, processing circuitry 120 also estimates at block 310 of FIG. 3 that if timing inefficiencies were removed from RLM entity 206 the propagation time attributable to RLM entity 206 could be reduced from 115 ps to an estimated 50 ps. As a result the total propagation time on the signal path could be reduced to an estimated 80 ps.

Processing circuitry 120 additionally determines at block 310 the estimated slack 404 of signal 212, which in the given example is 50 ps of negative slack (i.e., signal 212 misses the required arrival time at latch 214 by 50 ps). Rather than determining slack and apportioning slack based on calculated propagation time 400, processing circuitry 120 instead preferably apportions the estimated slack based on estimated propagation time 402. Processing circuitry 120 preferably apportions the slack proportionally among the components of the signal path. Thus, in the example given in FIG. 4, processing circuitry 120 proportionally allocates 63% of estimated slack 404 (i.e., −31.25 ps) to RLM entity 206, 13% of estimated slack 404 (i.e., −6.25 ps) to interconnect 218, and 25% of estimated slack 404 (i.e., −12.50 ps) to RLM entity 208 based on the respective contributions of each of these components to estimated propagation time 402.

FIG. 4 illustrates that processing circuitry 120 additionally determines the target propagation time 406 for signal 212 in the signal path for a subsequent iteration of timing analysis based on the estimated propagation time 402 and the apportionment of estimated slack 404. For example, given the proportional allocation of estimated slack 404 given above, the target propagation time 406 is 30 ps, which includes 18.75 ps of propagation time for RLM entity 206, 3.75 ps of propagation time for RLM entity 206, and 7.50 ps of propagation time for RLM entity 208. This target propagation time 406 will be utilized by processing circuitry 120 to determine the slack, if any, during a subsequent iteration of design refinement and timing analysis utilizing the method of FIG. 3. By estimating the slack with model inefficiencies removed, the integrated circuit design converges more rapidly and with fewer iterations to a final physical design because the estimated slack already approximates and the actual slack expected to be calculated for the next more refined version of the integrated circuit design. Although FIG. 4 provides a specific example of the apportionment of negative slack, it should be appreciated that the same process is applicable to the apportionment of positive slack.

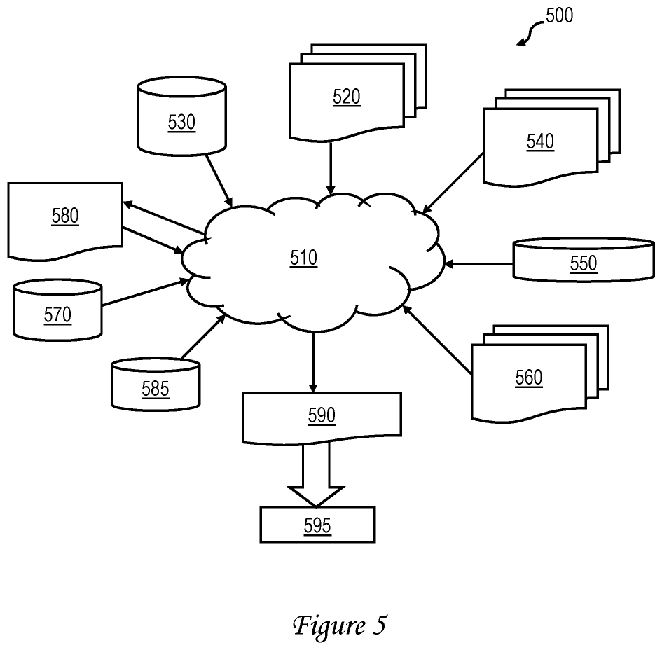

Referring now to FIG. 5, there is depicted a block diagram of an exemplary design flow 500 used for example, in semiconductor IC logic design, simulation, test, layout, and manufacture. As one example, design flow 500 can be utilized to design, simulation, test, layout, and manufacture integrated circuit design 200 of FIG. 2. Design flow 500 may in part be performed through execution of integrated circuit design tool 150 of FIG. 1. Design flow 500 includes processes, machines and/or mechanisms for processing design structures or devices to generate logically or otherwise functionally equivalent representations of the design structures and/or devices described above. The design structures processed and/or generated by design flow 500 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 500 may vary depending on the type of representation being designed. For example, a design flow 500 for building an application specific IC (ASIC) may differ from a design flow 500 for designing a standard component or from a design flow 500 for instantiating the design into a programmable array, for example a programmable gate array (PGA) or a field programmable gate array (FPGA) offered by Altera® Inc. or Xilinx® Inc.

FIG. 5 illustrates multiple such design structures including an input design structure 520 that is preferably processed by a design process 510. Design structure 520 may be a logical simulation design structure generated and processed by design process 510 to produce a logically equivalent functional representation of a hardware device. Design structure 520 may also or alternatively comprise data and/or program instructions that when processed by design process 510, generate a functional representation of the physical structure of a hardware device. Whether representing functional and/or structural design features, design structure 520 may be generated using electronic computer-aided design (ECAD) such as implemented by a core developer/designer. When encoded on a machine-readable data transmission, gate array, or storage medium, design structure 520 may be accessed and processed by one or more hardware and/or software modules within design process 510 to simulate or otherwise functionally represent an electronic component, circuit, electronic or logic module, apparatus, device, or system such as those shown herein. As such, design structure 520 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 510 preferably employs and incorporates hardware and/or software modules for synthesizing, translating, or otherwise processing a design/simulation functional equivalent of the components, circuits, devices, or logic structures shown herein to generate a netlist 580 which may contain design structures such as design structure 520. Netlist 580 may comprise, for example, compiled or otherwise processed data structures representing a list of wires, discrete components, logic gates, control circuits, I/O devices, models, etc. that describes the connections to other elements and circuits in an integrated circuit design. Netlist 580 may be synthesized using an iterative process in which netlist 580 is resynthesized one or more times depending on design specifications and parameters for the device. As with other design structure types described herein, netlist 580 may be recorded on a machine-readable storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, or buffer space.

Design process 510 may include hardware and software modules for processing a variety of input data structure types including netlist 580. Such data structure types may reside, for example, within library elements 530 and include a set of commonly used elements, circuits, and devices, including models, layouts, and symbolic representations, for a given manufacturing technology (e.g., different technology nodes, 7 nm, 10 nm, 20 nm, 30 nm, etc.). The data structure types may further include design specifications 540, characterization data 550, verification data 560, design rules 570, and test data files 585 which may include input test patterns, output test results, and other testing information. Design process 510 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 510 without deviating from the scope and spirit of the invention. Design process 510 may also include modules for performing standard circuit design processes such as timing analysis, verification, design rule checking, place and route operations, etc.

Design process 510 employs and incorporates logic and physical design tools such as HDL compilers and simulation model build tools to process design structure 520 together with some or all of the depicted supporting data structures along with any additional mechanical design or data (if applicable), to generate a second design structure 590. Design structure 590 resides on a storage medium or programmable gate array in a data format used for the exchange of data of mechanical devices and structures (e.g., information stored in an IGES, DXF, Parasolid XT, JT, DRG, or any other suitable format for storing or rendering such mechanical design structures). Similar to design structure 520, design structure 590 preferably comprises one or more files, data structures, or other computer-encoded data or instructions that reside on transmission or data storage media and that when processed by an ECAD system generate a logically or otherwise functionally equivalent form of one or more of the embodiments of the invention shown herein. In one embodiment, design structure 590 may comprise a compiled, executable HDL simulation model that functionally simulates one or more of the devices shown herein.

Design structure 590 may also employ a data format used for the exchange of layout data of integrated circuits and/or symbolic data format (e.g., information stored in a GDSII (GDS2), GL1, OASIS, map files, or any other suitable format for storing such design data structures). Design structure 590 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown herein. Design structure 590 may then proceed to a stage 595 where, for example, design structure 590: proceeds to tape-out, is released to manufacturing, is released to a mask house, is sent to another design house, is sent back to the customer, etc.

As has been described, in at least one embodiment, improvements are made to the apportionment of slack on a signal path of an integrated circuit design to accelerate design refinement. According to one exemplary method, timing analysis of the signal path of the integrated circuit design is performed. Estimated (as opposed to actual) slack on the signal path is determined through content-based analysis of components of the signal path based on elimination of timing inefficiencies within the components. The estimated slack is then proportionally apportioned among the components of the signal path for use in a subsequent iteration of design refinement.

The present invention may be implemented as a method, a system, and/or a computer program product. The computer program product may include a storage device having computer-readable program instructions (program code) thereon for causing a processor to carry out aspects of the present invention. As employed herein, a “storage device” is specifically defined to include only statutory articles of manufacture and to exclude signal media per se, transitory propagating signals per se, and energy per se.

Aspects of the present invention are described herein with reference to flowchart illustrations and/or block diagrams that illustrate the architecture, functionality, and operation of possible implementations of systems, methods, and computer program products according to various embodiments. It will be understood that each block of the block diagrams and/or flowcharts and combinations of blocks in the block diagrams and/or flowcharts can be implemented by special purpose hardware-based systems and/or program code that perform the specified functions. While the present invention has been particularly shown as described with reference to one or more preferred embodiments, it will be understood by those skilled in the art that various changes in form and detail may be made therein without departing from the spirit and scope of the invention.

The figures described above and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms and that multiple of the disclosed embodiments can be combined. Lastly, the use of a singular term, such as, but not limited to, “a” is not intended as limiting of the number of items.

What is claimed is:

1. A method of apportioning slack in an integrated circuit design, the method comprising:
performing, by processing circuitry of a data processing system, timing analysis of a signal path of an integrated circuit design;
the processing circuitry determining by content-based analysis of components of the signal path an estimated slack on the signal path based on elimination of timing inefficiencies; and
the processing circuitry proportionally apportioning the estimated slack among the components of the signal path for use in a subsequent iteration of design refinement.

2. The method of claim 1, wherein proportionally apportioning the estimated slack includes assigning each of the components of the signal path a portion of the estimated slack in accordance with a contribution of said each of the components to an estimated propagation time of a signal on the signal path.

3. The method of claim 1, wherein the estimated slack is positive slack.

4. The method of claim 1, further comprising:
based on the estimated slack, the processing circuitry determining a target propagation time for a signal on the signal path for use in the subsequent iteration of design refinement

5. The method of claim 1, further comprising the processing circuitry iteratively performing, for a plurality of design refinements:
the step of performing the timing analysis;
the step of determining the estimated slack; and
the step of proportionally apportioning the estimated slack.

6. The method of claim 1, wherein the processing circuitry determines the estimated slack based on a determination that a magnitude of a calculated slack for the signal path is greater than or equal to a threshold.

7. A program product, comprising:
a storage device; and
program code stored within the storage device and executable by processing circuitry of a data processing system to cause the data processing system to perform:
performing timing analysis of a signal path of an integrated circuit design;
determining by content-based analysis of components of the signal path an estimated slack on the signal path based on elimination of timing inefficiencies; and
proportionally apportioning the estimated slack among the components of the signal path for use in a subsequent iteration of design refinement.

8. The program product of claim 7, wherein proportionally apportioning the estimated slack includes assigning each of the components of the signal path a portion of the estimated slack in accordance with a contribution of said each of the components to an estimated propagation time of a signal on the signal path.

9. The program product of claim 7, wherein the estimated slack is positive slack.

10. The program product of claim 7, wherein the program code, when executed by the processing circuitry, further causes the processing circuitry to perform:
based on the estimated slack, determining a target propagation time for a signal on the signal path for use in the subsequent iteration of design refinement

11. The program product of claim 7, wherein the program code, when executed by the processing circuitry, further causes the processing circuitry to iteratively perform timing analysis, determine the estimated slack, and proportionally apportion the estimated slack for a plurality of design refinements.

12. The program product of claim 7, wherein the program code causes the processing circuitry to determine the estimated slack based on a determination that a magnitude of a calculated slack for the signal path is greater than or equal to a threshold.

13. A data processing system, comprising:
processing circuitry; and
a storage device communicatively coupled to the processing; and
program code stored within the storage device and executable by the processing circuitry of the data processing system to cause the data processing system to perform:
performing timing analysis of a signal path of an integrated circuit design;
determining by content-based analysis of components of the signal path an estimated slack on the signal path based on elimination of timing inefficiencies; and
proportionally apportioning the estimated slack among the components of the signal path for use in a subsequent iteration of design refinement.

14. The data processing system of claim 13, wherein proportionally apportioning the estimated slack includes assigning each of the components of the signal path a portion of the estimated slack in accordance with a contribution of said each of the components to an estimated propagation time of a signal on the signal path.

15. The data processing system of claim 13, wherein the estimated slack is positive slack.

16. The data processing system of claim 13, wherein the program code, when executed by the processing circuitry, further causes the processing circuitry to perform:
based on the estimated slack, determining a target propagation time for a signal on the signal path for use in the subsequent iteration of design refinement

17. The data processing system of claim 13, wherein the program code, when executed by the processing circuitry, further causes the processing circuitry to iteratively perform timing analysis, determine the estimated slack, and proportionally apportion the estimated slack for plurality of design refinements.

18. The data processing system of claim 13, wherein the program code causes the processing circuitry to determine the estimated slack based on a determination that a magnitude of a calculated slack for the signal path is greater than or equal to a threshold.
